(19) United States
(12) Patent Application Publication
(10) Pub. No.: US 2026/0051497 A1
(43) Pub. Date: Feb. 19, 2026

(54) CHLORIDE CATHOLYTE COMPOUNDS, CATHODE COMPOSITES, AND SOLID STATE BATTERIES MADE THEREWITH

(71) Applicant: The Regents of the University of California, Oakland, CA (US)

(72) Inventors: Phillip Ridley, San Diego, CA (US); George Duong, Los Angeles, CA (US); Ying Shirley Meng, San Diego, CA (US)

(21) Appl. No.: 19/301,429

(22) Filed: Aug. 15, 2025

Related U.S. Application Data
(60) Provisional application No. 63/683,896, filed on Aug. 16, 2024.

(51) Int. Cl. H01M 4/62; H01M 4/131; H01M 4/485; H01M 10/054

(52) U.S. Cl. CPC H01M 4/62; H01M 4/131; H01M 4/485; H01M 4/625; H01M 10/054

(57) ABSTRACT

A cathode composite may comprise about 5% wt/wt to about 99% wt/wt of Na_{2+(4-y)x}MₓZr₁₋ₓCl₆ or Li_{2+(4-y)x}MₓZr₁₋ₓCl₆ and a cathode material as a balance thereof. The cathode material is selected from the group consisting of a carbon-based conductive material, a Na-ion O₃-type layered oxide material, a polyanion-type cathode material, and combinations thereof. x is 0≤x≤1, M is a cation, y is M's valence numbers, and M is selected from the group consisting of a Nb⁵⁺, Ta⁵⁺, V⁵⁺, Cr³⁺, Mo⁶⁺, Mo⁴⁺, W⁶⁺, W⁴⁺, Mn²⁺, Mn⁴⁺, Mn⁵⁺, Fe³⁺, Fe²⁺, Co³⁺, Co²⁺, Ni³⁺, Ni²⁺, and combinations thereof. A solid-state battery may comprise a housing enclosing an anode and the cathode composite. The cathode composition may function as a cathode and as a solid electrolyte.

### RELATED APPLICATION

This application claims the benefit of U.S. Provisional Application No. 63/683,896, filed Aug. 16, 2024, which is incorporated herein by reference in its entirety.

### TECHNICAL FIELD

In some example embodiments, there may be provided systems, methods, and articles of manufacture for chloride catholyte compounds, cathode composites, and solid state batteries made therewith, more particularly a cathode composite comprising an aliovalent substituted solid electrolyte material has the general formula (I) Na_{2+(4-y)x}MₓZr₁₋ₓCl₆ or (II) Li_{2+(4-y)x}MₓZr₁₋ₓCl₆ and a cathode material as the balance thereof.

### BACKGROUND

Next-generation energy storage technologies, like solid-state batteries, possess the potential to supplant existing lithium-ion batteries in applications where both high energy density and safety are required. Substituting liquid electrolytes for inorganic solid-state electrolytes brings the advantage of reduced fire risk (i.e., enhanced safety) while also enabling metallic or alloying-type anodes, which increase cell-level energy density due to their very high specific capacities. As such, the physical and chemical properties of the solid-state electrolyte are fundamental to the operation and performance of the solid-state battery cell. Various chemistries have been explored (i.e., oxides, sulfides, halides, and borohydrides), leading to the discovery of many highly conductive materials. Oftentimes, combinations of two or more different chemistries (i.e., halide and borohydride) are chosen to form stable cathode and anode interfaces, thus leading to two separate electrolytes, namely the catholyte and anolyte. While both types of electrolyte must possess favorable mechanical properties and high ionic conductivity, the catholyte must also be able to withstand the highly oxidative environment of the cathode material. Few catholyte materials possess these necessary properties to enable high coulombic efficiencies and industrially relevant cathode areal capacities.

Chloride-based solid electrolytes have emerged as promising materials to enable oxide-based cathodes due to their low Young's modulus, high conductivity, and superior oxidation stability. Recent reports have demonstrated the potential of such chloride-based electrolytes, specifically an electrolyte with composition Na_{2.25}Y_{0.25}Zr_{0.75}Cl₆ was paired with NaCrO₂, where stable cycling (>1000 cycles) was achieved in a pellet-type cell.

Chloride-based electrolytes form stable interfaces with oxide-based cathodes, like NaCrO₂, because they are electrochemically inactive by design. However, fabricating a cathode electrode requires adding a large amount of solid electrolyte (usually >40 wt %) to provide ample ionically conductive pathways for ion diffusion. Doing so, by necessity, results in a drastic decrease in the real energy density of the cell. To overcome this issue and deliver a solid-state battery which truly possesses superior energy density to that of a lithium-ion cell, high cathode fractions (e.g., >80 weight %) are necessary. Enabling a high fraction of cathode active material is challenging due to the relatively high densities of solid electrolytes compared to liquid electrolytes, which then requires larger weight fractions in order to achieve sufficient volumetric fractions for ion percolation.

There is a need to improve the cathode and the solid electrolyte to provide ample ionically conductive pathways, superior energy density with reduced cost, ease of manufacturing, and improved battery characteristics.

### SUMMARY

A first aspect of the disclosed embodiments provides a cathode composite comprising about 5% wt/wt to about 99% wt/wt of Na_{2+(4-y)x}MₓZr₁₋ₓCl₆ or Li_{2+(4-y)x}MₓZr₁₋ₓCl₆ and a cathode material as a balance thereof. The cathode material is selected from the group consisting of a carbon-based conductive material, a Na-ion O₃-type layered oxide material, a polyanion-type cathode material, and combinations thereof. x is 0≤x≤1, M is a cation, y is M's valence numbers, and M is selected from the group consisting of a Nb⁵⁺, Ta⁵⁺, V⁵⁺, Cr³⁺, Mo⁶⁺, Mo⁴⁺, W⁶⁺, W⁴⁺, Mn²⁺, Mn⁴⁺, Mn⁵⁺, Fe³⁺, Fe²⁺, Co³⁺, Co²⁺, Ni³⁺, Ni²⁺, and combinations thereof. A solid-state battery may comprise a housing enclosing an anode and the cathode composite. The cathode composite may comprise about 5% wt/wt to about 99% wt/wt of Na_{2+(4-y)x}MₓZr₁₋ₓCl₆ or Li_{2+(4-y)x}MₓZr₁₋ₓCl₆ and a cathode material as a balance thereof. The cathode material is selected from the group consisting of a carbon-based conductive material, a Na-ion O₃-type layered oxide material, a polyanion-type cathode material, and combinations thereof. The cathode composition may function as a cathode and as a solid electrolyte. The Na_{2+(4-y)x}MₓZr₁₋ₓCl₆ or Li_{2+(4-y)x}MₓZr₁₋ₓCl₆ may comprise at least 20% wt/wt of the cathode composite. The Na_{2+(4-y)x}MₓZr₁₋ₓCl₆ or Li_{2+(4-y)x}MₓZr₁₋ₓCl₆ may comprise at least 50% wt/wt of the cathode composite.

The Na-ion O₃-type layered oxide or polyanion-type material may be present without the carbon-based conductive material. When the Na-ion O₃-type layered oxide or polyanion-type material is present, it can be selected from the group consisting of sodium chromium oxide (NaCrO₂), sodium nickel iron manganese oxide NaNi_{1/3}Fe_{1/3}Mn_{1/3}O₂, iron-based mixed phosphate-pyrophosphate Na₂Fe₃(PO₄)₂(P₂O₇), sodium vanadium phosphate (Na₃V₂(PO₄)₃), sodium titanium, phosphate (NaTi₂(PO₄)₃), sodium iron sulfide (Na₂FeS₂), LiCoO₂, LiMnxNiyCozO₂, LiFePO₄, and LiFexMnyPO₄, and combinations thereof.

The carbon-based conductive material may be present without the Na-ion O₃-type layered oxide material. The carbon-based conductive material may be present without the polyanion-type material. The carbon-based conductive material can be selected from the group consisting of carbon nanofiber, vapor grown carbon fiber, graphene, carbon nanotubes, carbon black, carbon dots, graphite, and combinations thereof. The Na-ion O₃-type layered oxide may be present with the carbon-based conductive material. The polyanion-type material can be present with the carbon-based conductive material.

In one embodiment, M, which is a cation represented as M^{y+}, is selected from Nb⁵⁺ and Ta⁵⁺ where y is 5. The cathode composite may be about 5% wt/wt to about 99% wt/wt of Na₂₋ₓNbₓZr₁₋ₓCl₆ or Li₂₋ₓNbₓZr₁₋ₓCl₆ and a carbon-based conductive material. The cathode composite may be about 5% wt/wt to about 99% wt/wt of Na₂₋ₓNbₓZr₁₋ₓCl₆ or Li_{2+(4-y)x}NbₓZr₁₋ₓCl₆ and a Na-ion O₃-type layered oxide. The cathode composite may be about 5% wt/wt to about 99% wt/wt of Na₂₋ₓNbₓZr₁₋ₓCl₆ or Li₂₋ₓNbₓZr₁₋ₓCl₆ with a mixture of carbon-based conductive material and a Na-ion O₃-type layered oxide or polyanion-type cathode material. Alternately, the cathode composite may be about 5% wt/wt to about 99% wt/wt of Na₂₋ₓTaₓZr₁₋ₓCl₆ or Li₂₋ₓTaₓZr₁₋ₓCl₆ and a carbon-based conductive material. The cathode composite may be about 5% wt/wt to about 99% wt/wt of Na₂₋ₓTaₓZr₁₋ₓCl₆ or Li₂₋ₓTaₓZr₁₋ₓCl₆ and a Na-ion O₃-type layered oxide. The cathode composite may be about 5% wt/wt to about 99% wt/wt of Na₂₋ₓTaₓZr₁₋ₓCl₆ or Li₂₋ₓTaₓZr₁₋ₓCl₆ with a mixture of carbon-based conductive material and a Na-ion O₃-type layered oxide. For each of these embodiments, x is in a range of 0≤x≤1. For any or all of these embodiments, x can be 1, 0.25, 0.5, 0.75, 1, as several non-limiting examples.

A second aspect of the disclosed embodiments may provide a solid-state battery comprising a housing enclosing an anode and a cathode composite. The cathode composite being any of those described above and herein.

A third aspect of the disclosed embodiments is a method of making a cathode composite. The method includes providing an aliovalent substituted solid electrolyte material having a general formula of

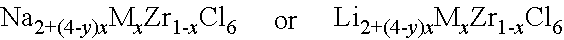

wherein x is 0≤x≤1, M is a cation, and y is M's valence numbers; and M is selected from the group consisting of a Nb⁵⁺, Ta⁵⁺, V⁵⁺, Cr³⁺, Mo⁶⁺, Mo⁴⁺, W⁶⁺, W⁴⁺, Mn²⁺, Mn⁴⁺, Mn⁵⁺, Fe³⁺, Fe²⁺, Co³⁺, Co²⁺, Ni³⁺, Ni²⁺, and combinations thereof, providing a cathode material, and mixing the aliovalent substituted solid electrolyte material with the cathode material to form a cathode composite. The cathode material is selected from the group consisting of a carbon-based conductive material, a Na-ion O₃-type layered oxide material, a polyanion-type cathode material, and combinations thereof.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a general representation of a solid state battery having a cathode composite disclosed herein.

FIG. 2A is a general representation of a pellet style solid state battery having a cathode composite that includes a carbon-based conductive material disclosed herein.

FIG. 2B is general representation of a pellet style solid state battery having a cathode composite without a carbon-based conductive material disclosed herein.

FIG. 3 is a ternary NaCl—NbCl₅—ZrCl₄ phase diagram illustrating synthesized Na₂₋ₓMₓZr₁₋ₓCl₆ where M can equal Nb or Ta, (0≤x≤1).

FIG. 4 is a graph of energy distribution as a function of cathode weight fraction.

FIG. 5 sets forth X-ray diffraction patterns for Na₂₋ₓNbₓZr₁₋ₓCl₆ (0≤x≤1) and Na₂₋ₓTaₓZr₁₋ₓCl₆ (0≤x≤1) solid electrolyte compositions, respectively.

FIG. 6A is a Le Bail refinement result for NaTaCl₆.

FIG. 6B is a Le Bail refinement result for NaNbCl₆.

FIG. 6C is a Le Bail refinement result for Na_{1.5}Ta_{0.5}Zr_{0.5}Cl₆.

FIG. 6D is a Le Bail refinement result for Na_{1.5}Nb_{0.5}Zr_{0.5}Cl₆.

FIG. 6E is a Le Bail refinement result for Na₂ZrCl₆.

FIG. 7A is a graph of lattice parameters for Na₂₋ₓNbₓZr₁₋ₓCl₆ (0≤x≤1) from a Le Bail refinement.

FIG. 7B is a graph of β (degree) for Na₂₋ₓNbₓZr₁₋ₓCl₆ (0≤x≤1) from a Le Bail refinement.

FIG. 7C is a graph of cell volumes for Na₂₋ₓNbₓZr₁₋ₓCl₆ (0≤x≤1) using the monoclinic P2_{1/n} space groups.

FIG. 8A is a bar graph of room temperature conductivity for Na₂₋ₓNbₓZr₁₋ₓCl₆ (0≤x≤1).

FIG. 8B is a bar graph of room temperature conductivity for Na₂₋ₓNbₓZr₁₋ₓCl₆ (0≤x≤1).

FIG. 8C is a graph showing corresponding cell volumes for the catholytes of FIGS. 6A and 6B.

FIG. 9A is a graph showing voltage profiles for a cathode composite consisting of 40% by wt NaCrO₂ and 58% by wt Na_{1.5}Ta_{0.5}Zr_{0.5}Cl₆ (balance carbon-based conductive material).

FIG. 9B is a graph showing voltage profiles for a cathode composite consisting of 40% by wt NaCrO₂ and 58% by wt Na_{1.5}Nb_{0.5}Zr_{0.5}Cl₆ (balance carbon-based conductive material).

FIG. 9C is a graph showing voltage profiles for a cathode composite consisting of 96% by wt NaNbCl₆ (balance carbon-based conductive material).

FIG. 9D is a graph showing voltage profiles for a cathode composite consisting of 96% by wt Na_{1.5}Nb_{0.5}Zr_{0.5}Cl₆ (balance carbon-based conductive material).

FIG. 10A is a graph showing voltage profiles for a cathode composite consisting of 40% by wt NaCrO₂ and 58% by wt NaZrCl₆ (balance carbon-based conductive material).

FIG. 10B is a graph showing voltage profiles for a cathode composite consisting of 40% by wt NaCrO₂ and 58% by wt Na_{1.5}Ta_{0.5}Zr_{0.5}Cl₆ (balance carbon-based conductive material).

FIG. 10C is a dQ/dV plot for a cathode composite consisting of 40% by wt NaCrO2 and 58% by wt Na_{1.5}Ta_{0.5}Zr_{0.5}Cl₆ (balance carbon-based conductive material).

FIG. 10D is an extended cycling plot for a cathode composite consisting of 40% by wt NaCrO₂ and 58% by wt Na_{1.5}Ta_{0.5}Zr_{0.5}Cl₆ (balance carbon-based conductive material).

### DETAILED DESCRIPTION

The solid electrolyte is essential to the functionality of a solid-state battery, serving as its core component. It establishes direct physical contact with the electrode substances (such as oxide cathodes or carbon-based anode materials), thereby offering channels for ion diffusion. This enables the bidirectional flow of ions that carry charge, specifically cations like Li⁺ or Na⁺. For optimal performance, the solid electrolyte must exhibit several key characteristics: high ionic conductivity, mechanical pliability (i.e., low Young's modulus), and robust electrochemical stability. High ionic conductivity is vital to facilitate the swift migration of charged cation species, averting negative kinetic phenomena, such as overpotential, which arises from the total resistance of the cell. Mechanical pliability is crucial for initially creating intimate contact between the electrolyte and electrode materials, particularly during the cold pressing stages of production. Furthermore, electrochemical stability may curb the generation of degrading compounds at the interface during battery cycling, thus preserving the integrity of the cathode-electrolyte boundary. In contrast to liquid-based batteries, solid electrolytes are denser—often two to three times heavier than their liquid counterparts—reducing the cell's gravimetric energy density. This factor is particularly relevant when considering that the cathode electrode often contains roughly 20-40 wt. % of solid electrolyte. Therefore, it may be considered, in some instances, critical to reduce the “deadweight” of the solid electrolyte. Disclosed herein is a solution that integrates redox-active metal centers within the solid electrolyte crystal structure by leveraging an aliovalent substitution approach.

Consequently, the solid electrolyte not only acts as an electrolyte but also as a cathode when made part of a cathode composite, contributing to the cell's total capacity while simultaneously providing ionic transport pathways directly to the cathode active material.

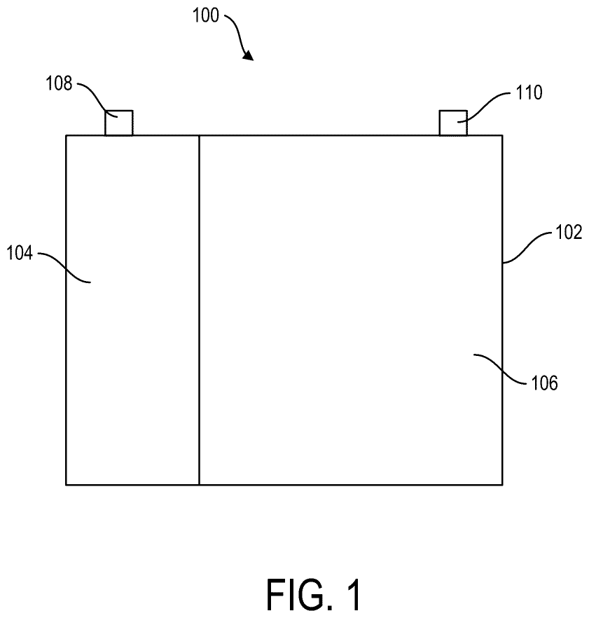

Referring to FIG. 1, a solid-state battery, generally referenced as 100, has a housing 102 enclosing an anode 104 and a cathode composite 106. The battery 100 includes a negative terminal 108 and a positive terminal 110. Unlike conventional solid-state batteries, there is no distinct solid electrolyte layer between the anode and the cathode composite. Rather, the material that can function as a solid state electrolyte has been modified by aliovalent substitution and combined with a cathode material to form the cathode composite. The aliovalent substituted solid electrolyte can be about 5% wt/wt to about 99% wt/wt of the cathode composite. The cathode composite is selected from the group consisting of a carbon-based conductive material, a Na-ion O₃-type layered oxide material, a polyanion-type cathode material, and combinations thereof as the balance thereof. In one aspect the aliovalent substituted solid electrolyte material has the general formula (I) or (II).

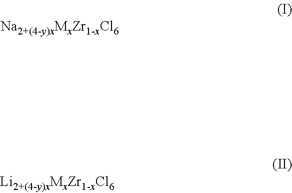

wherein x is 0≤x≤1, M is a cation, y is M's valence numbers, and M is selected from the group consisting of a Nb⁵⁺, Ta⁵⁺, V⁵⁺, Cr³⁺, Mo⁶⁺, Mo⁴⁺, W⁶⁺, W⁴⁺, Mn²⁺, Mn⁴⁺, Mn⁵⁺, Fe³⁺, Fe²⁺, Co³⁺, Co²⁺, Ni³⁺, Ni²⁺, and combinations thereof. In all embodiments, the cathode composition functions as a cathode and as a solid electrolyte. In all embodiments, the concentration of the aliovalent substituted solid electrolyte in the cathode composite can be in a range of about 10% wt/wt to about 99% weight, preferably about 20% weight to about 99% weight, more preferably about 20% wt/wt to about 80% wt/wt. In other embodiments, the aliovalent substituted solid electrolyte in the cathode composite can be in a range of about 20% wt/wt to about 70% weight, about 20% to about 60% wt/wt, or about 20% to about 40% wt/wt.

A Na-ion O3-type layered oxide may be present without the carbon-based conductive material. A Na-ion O3-type layered oxide may comprise sodium chromium oxide (NaCrO2). The carbon-based conductive material may be present without a Na-ion O3-type layered oxide material. The carbon-based conductive material may comprise a carbon nanofiber. A Na-ion O3-type layered oxide may be present with the carbon-based conductive material. The carbon-based conductive material may be selected from the group consisting of carbon nanofiber, vapor grown carbon fiber, graphene, carbon nanotubes, porous carbon, carbon black, carbon dots, graphite, hard carbon, soft carbon, and combinations thereof. In all embodiments, the cathode composite can include a binder. Typically, a binder is added to improve mechanical integrity of the cathode during large scale processing/manufacturing. Any binder suitable for this purpose can be included. The binder may be present as less than 5% wt/wt site, less than 4% wt/wt, less than 3% wt/wt, less than 2% wt/wt, and less than 1% wt/wt of the cathode composite. Some non-limiting examples of binders includes polytetrafluoroethylene (PTFE), carboxymethyl cellulose (CMC), polyvinylidene fluoride (PVDF), hydrogenated nitrile butadiene rubber (HNBR), polyacrylic acid (PAA), polyvinyl alcohol, styrene butadiene rubber (SBS), and combinations thereof.

In one embodiment, M, which is a cation represented as M^{y+}, has a valence of 5+ and is selected from Nb⁵⁺, Ta⁵⁺, V⁵⁺, or Mn⁵. The cathode composite may be about 5% wt/wt to about 99% wt/wt of Na₂₋ₓNbₓZr₁₋ₓCl₆ and a carbon-based conductive material. The cathode composite may be about 5% wt/wt to about 99% wt/wt of Na₂₋ₓNbₓZr₁₋ₓCl₆ and a Na-ion O3-type layered oxide. The cathode composite may be about 5% wt/wt to about 99% wt/wt of Na₂₋ₓNbₓZr₁₋ₓCl₆ with a mixture of carbon-based conductive material and a Na-ion O3-type layered oxide. The cathode composite may be about 5% wt/wt to about 99% wt/wt of Na₂₋ₓNbₓZr₁₋ₓCl₆ and a poly-polyanion-type cathode material. Alternately, the cathode composite may be about 5% wt/wt to about 99% wt/wt of Na₂₋ₓTaₓZr₁₋ₓCl₆ and a carbon-based conductive material. The cathode composite may be about 5% wt/wt to about 99% wt/wt of Na₂₋ₓTaₓZr₁₋ₓCl₆ and a Na-ion O3-type layered oxide. The cathode composite may be about 5% wt/wt to about 99% wt/wt of Na₂₋ₓTaₓZr₁₋ₓCl₆ with a mixture of carbon-based conductive material and a Na-ion O3-type layered oxide. The cathode composite may be about 5% wt/wt to about 99% wt/wt of Na₂₋ₓTaₓZr₁₋ₓCl₆ and a poly-polyanion-type cathode material. For each of these embodiments, x is in a range of 0≤x≤1. For any or all of these embodiments, x can be 1, 0.25, 0.5, 0.75, 1, as several non-limiting examples. Likewise, each of the above could be Li₂₋ₓNbₓZr₁₋ₓCl₆ or Li₂₋ₓTaₓZr₁₋ₓCl₆, Na₂₋ₓVₓZr₁₋ₓCl₆ or Li₂₋ₓVₓZr₁₋ₓCl₆ or Na₂₋ₓMnₓZr₁₋ₓCl₆ or Li₂₋ₓMnₓZr₁₋ₓCl₆.

In another embodiment, M, which is a cation represented as M^{y+}, has a valence of 4+ and is selected from Mo⁴⁺, W⁴⁺, Mn⁴⁺. The cathode composite may be about 5% wt/wt to about 99% wt/wt of Na₂MoₓZr₁₋ₓCl₆ and a carbon-based conductive material. The cathode composite may be about 5% wt/wt to about 99% wt/wt of Na₂MoₓZr₁₋ₓCl₆ and a Na-ion O3-type layered oxide. The cathode composite may be about 5% wt/wt to about 99% wt/wt of Na₂MoₓZr₁₋ₓCl₆ with a mixture of carbon-based conductive material and a Na-ion O3-type layered oxide. The cathode composite may be about 5% wt/wt to about 99% wt/wt of Na₂MoₓZr₁₋ₓCl₆ and a poly-polyanion-type cathode material. For each of these embodiments, x is in a range of 0≤x≤1. For any or all of these embodiments, x can be 1, 0.25, 0.5, 0.75, 1, as several non-limiting examples. Likewise, each of the above could be Li₂MoₓZr₁₋ₓCl₆, or Na₂WₓZr₁₋ₓCl₆ or Li₂WₓZr₁₋ₓCl₆, or Na₂MnₓZr₁₋ₓCl₆ or Li₂MnₓZr₁₋ₓCl₆.

In another embodiment, M, which is a cation represented as M^{y+}, has a valence of 3+ and is selected from Cr³⁺, Fe³⁺, Co³⁺, or Ni³⁺. The cathode composite may be about 5% wt/wt to about 99% wt/wt of Na₂₊ₓCrₓZr₁₋ₓCl₆ and a carbon-based conductive material. The cathode composite may be about 5% wt/wt to about 99% wt/wt of Na₂₊ₓCrₓZr₁₋ₓCl₆ and a Na-ion O3-type layered oxide. The cathode composite may be about 5% wt/wt to about 99% wt/wt of Na₂₊ₓCrₓZr₁₋ₓCl₆ with a mixture of carbon-based conductive material and a Na-ion O3-type layered oxide. The cathode composite may be about 5% wt/wt to about 99% wt/wt of Na₂₊ₓCrₓZr₁₋ₓCl₆ and a poly-polyanion-type cathode material. For each of these embodiments, x is in a range of 0≤x≤1. For any or all of these embodiments, x can be 1, 0.25, 0.5, 0.75, 1, as several non-limiting examples. Likewise, each of the above could be Li₂₊ₓCrₓZr₁₋ₓCl₆, or Na₂₊ₓFeₓZr₁₋ₓCl₆ or Li₂₊ₓFeₓZr₁₋ₓCl₆, or Na₂₊ₓCoₓZr₁₋ₓCl₆ or Li₂₊ₓCoₓZr₁₋ₓCl₆, or Na₂₊ₓNiₓZr₁₋ₓCl₆ or Li₂₊ₓNiₓZr₁₋ₓCl₆.

In another embodiment, M, which is a cation represented as M^{y+}, has a valence of 2+ and is selected from Mn²⁺, Fe²⁺, Co²⁺, Ni²⁺. The cathode composite may be about 5% wt/wt to about 99% wt/wt of Na₂₊₂ₓMnₓZr₁₋ₓCl₆ and a carbon-based conductive material. The cathode composite may be about 5% wt/wt to about 99% wt/wt of Na₂₊₂ₓMnₓZr₁₋ₓCl₆ and a Na-ion O3-type layered oxide. The cathode composite may be about 5% wt/wt to about 99% wt/wt of Na₂₊₂ₓMnₓZr₁₋ₓCl₆ with a mixture of carbon-based conductive material and a Na-ion O3-type layered oxide. The cathode composite may be about 5% wt/wt to about 99% wt/wt of Na₂₊₂ₓMnₓZr₁₋ₓCl₆ and a poly-polyanion-type cathode material. For each of these embodiments, x is in a range of 0≤x≤1. For any or all of these embodiments, x can be 1, 0.25, 0.5, 0.75, 1, as several non-limiting examples. Likewise, each of the above could be Li₂₊₂ₓMnₓZr₁₋ₓCl₆, or Na₂₊₂ₓFeₓZr₁₋ₓCl₆ or Li₂₊₂ₓFeₓZr₁₋ₓCl₆, or Na₂₊₂ₓCoₓZr₁₋ₓCl₆ or Li₂₊₂ₓCoₓZr₁₋ₓCl₆, or Na₂₊₂ₓNiₓZr₁₋ₓCl₆ or Li₂₊₂ₓNiₓZr₁₋ₓCl₆.

In another embodiment, M, which is a cation represented as M^{y+}, has a valence of 6+ and is selected from Mo⁶*, W⁶⁺. The cathode composite may be about 5% wt/wt to about 99% wt/wt of Na₂₋₂ₓMoₓZr₁₋ₓCl₆ and a carbon-based conductive material. The cathode composite may be about 5% wt/wt to about 99% wt/wt of Na₂₋₂ₓMoₓZr₁₋ₓCl₆ and a Na-ion O3-type layered oxide. The cathode composite may be about 5% wt/wt to about 99% wt/wt of Na₂₋₂ₓMoₓZr₁₋ₓCl₆ with a mixture of carbon-based conductive material and a Na-ion O3-type layered oxide. The cathode composite may be about 5% wt/wt to about 99% wt/wt of Na₂₋₂ₓMoₓZr₁₋ₓCl₆ and a poly-polyanion-type cathode material. For each of these embodiments, x is in a range of 0≤x≤1. For any or all of these embodiments, x can be 1, 0.25, 0.5, 0.75, 1, as several non-limiting examples. Likewise, each of the above could be Li₂₋₂ₓMoₓZr₁₋ₓCl₆, or Na₂₋₂ₓWₓZr₁₋ₓCl₆ or Li₂₋₂ₓWₓZr₁₋ₓCl₆.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the present specification and claims can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter and the word “about” as applied thereto should at least be construed in light of the number of reported significant digits and by applying ordinary rounding techniques.

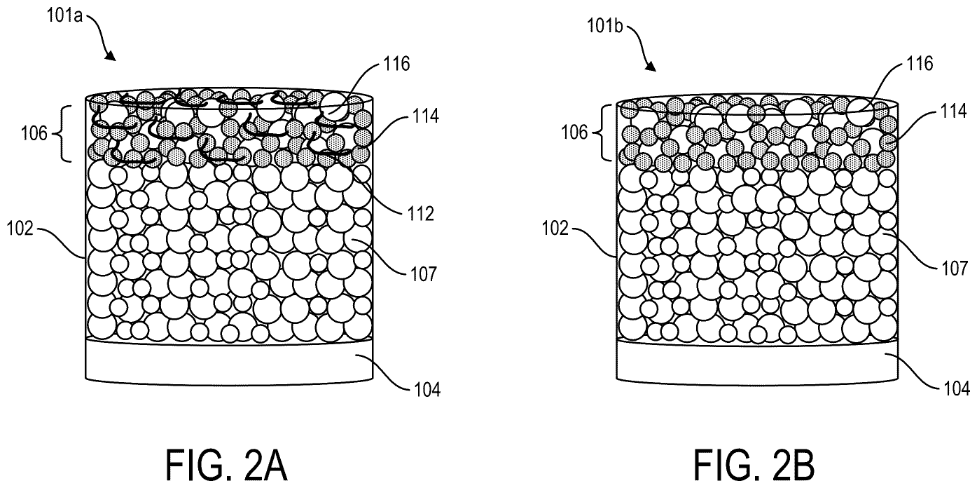

Referring to FIGS. 2A and 2B, a pellet cell style solid-state battery 101 is shown, respectively 101a and 101b. Each pellet cell 101 has a housing 102 with an anode 104 at a first surface, a cathode composite 106 at a second surface, and encloses therebetween a bilayer electrolyte separator 107. These non-limiting examples have a cathode composite 106 represented as having an aliovalent substituted solid electrolyte material 114, a Na-ion O3-type layered oxide 116 (pellet cell 101b in FIG. 2B), and optionally, a carbon-based conductive material 112 (pellet cell 101a in FIG. 2A). FIG. 2A illustrates the carbon-based conductive material 112 as carbon fibers, which can be solid fibers, carbon nanotubes of any construction (hollow, solid, or otherwise), or the like. The cathode composite may be homogenous or heterogeneous, with homogenous being preferred. In one embodiment, the anode is Na₉Sn₄, the bilayer electrolyte separator is Na₄(B₁₀H₁₀)(B₁₂H₁₂), and the cathode composite includes NaCrO₂ and any one or more of the sodium aliovalent substituted solid electrolyte material disclosed herein. In all embodiments, an aliovalent substituted solid electrolyte can be present as the separator between the anode and the cathode composite. The aliovalent substituted solid electrolyte can be the same or different from the one in the cathode composite. In one embodiment, the cathode composite and the aliovalent substituted solid electrolyte as the separator are the same aliovalent substituted solid electrolyte material and can be formed as a two part structure or as a single structure with a gradient of the aliovalent substituted solid electrolyte material.

An aliovalent substitution-based synthesis strategy is provided to modify a known solid electrolyte to enable reversible redox properties. By doing so, the solid electrolyte not only serves as an electrolyte providing ionic pathways for ion diffusion but also possesses active sites for reversible ion intercalation. This solves the deadweight issue associated with employing a solid electrolyte and effectively improves the ‘real’ energy density of the solid-state battery. This improvement in energy density (which is owed at least in part to the novel materials disclosed herein) drastically enhances the commercial viability of the sodium solid-state battery.

Starting with the Na₂ZrCl₆ material, redox active metal centers such as V, Nb, Ta, Cr, Mo, W, Mn, Fe, Co, and/or Ni, can be substituted on the Zr⁴⁺ site. Metal centers of 3⁺ valency will lead to a reduction in Na-ion vacancy density, while Metal centers of 5⁺ valency increase Na-ion vacancy density. As representative but non-limiting examples, Nb⁵⁺ and Ta⁵⁺ were selected as case studies to not only provide redox active metal centers, but to also increase the Na-ion vacancy concentration as a means to enhance Na-ion conductivity. This creates a synergistic effect whereby increased vacancy density leads to lower activation energy for Na-ion hopping, increased ionic conductivity, and open sites for reversible Na-ion storage.

### Example 1: Solid Electrolyte Synthesis

All Na₂₋ₓMₓZr₁₋ₓCl₆ (M=Nb or Ta, x=0.25, 0.5, 0.75) electrolytes were prepared in an inert, Ar-rich glovebox (e.g., MBRAUN MB200B: H2O˜1.0 ppm and O2˜5.0 ppm) using stoichiometric amounts of anhydrous NaCl (e.g., Sigma Aldrich, ≥99%), TaCl₅ (e.g., STREM, 99.99%), NbCl₅ (e.g., STREM, 99.99%), and ZrCl₄ (e.g., STREM, 99.95%) for a 1 g batch. The powders were weighed using an analytical balance (e.g., Ohaus Pioneer) and for example hand mixed (although other mixing approaches may be used) using a mortar and pestle. Mixtures were then transferred into 50 mL zirconia-lined ball milling jars loaded with 30 g of 5 mm zirconia milling media. The samples were ball milled (e.g., Retsch Emax) for 10 h at 500 rpm in 15 min milling intervals, followed by a 1 min rest period.

### Example 2: Electrochemical Measurements

Electrochemical impedance spectroscopy (EIS): Ionic conductivities for all electrolyte samples were calculated from Nyquist plots obtained using an applied voltage of 10 mV and a frequency range of 1 Hz to 1 MHz using a BioLogic SP-300. A symmetric cell in the form AB|SE|AB was constructed by filling a 10 mm diameter polyether ether ketone (PEEK) die with 100 mg of solid electrolyte powder which was pelletized with two Ti plungers at 310 MPa using a hydraulic press (Carver). The Ti plungers were removed and approximately 2 mg to 5 mg of Acetylene Black was densified to 250 MPa on both sides of the pellet to promote current collector contact. The symmetric cell was secured to a holder that applied a stack pressure of approximately 70 MPa.

Direct-current polarization (DCP): Electronic conductivities for all electrolyte samples were extracted from DCP performed on a Solartron 1260 impedance analyzer by applying a potential of 0.05 V for 500 s. Symmetric cells used to perform DCP measurements were prepared identically to those used for EIS.

Linear sweep voltammetry (LSV): Oxidation and reduction stabilities for all electrolyte samples were explored using linear sweep voltammetry from 0V to 6V (vs Na₉Sn₄). A positive electrode composite consisting of 96% Na₂₋ₓMₓZr₁₋ₓCl₆ (M=Ta or Nb; x=0.25, 0.5, 0.75) solid electrolyte and 4% vapor-grown carbon fiber (VGCF) was formed via hand-mixing in a mortar and pestle. A pellet cell was assembled in 10 mm diameter PEEK die via densification with a hydraulic press (e.g., Carver brand) using two Ti plunger current collectors. First, a bilayer electrolyte separator consisting of 20 mg Na₄B₁₀H₁₀B₁₂H₁₂ (NBH) and 50 mg of Na₂₋ₓMₓZr₁₋ₓCl₆ was formed via densification at 125 MPa. About 12 mg of positive electrode composite was added facing Na₂₋ₓMₓZr₁₋ₓCl₆ while 35 mg of the Na₉Sn₄ negative electrode was added facing NBH. The cell was then densified at 370 MPa and attached to a holder. Separate LSV measurements were performed scanning from open-circuit voltage (OCV) to 0V for reduction and OCV to 6V for oxidation at a rate of 0.100 mV/s on BioLogic SP-300 under inert conditions at room temperature.

### Example 3: Battery Testing

Electrochemical performance was examined by constructing NaASSB half-cells using a NaCrO₂ (NCO) positive electrode, Na₉Sn₄ negative electrode, and NBH electrolyte separator. To incorporate Na₂₋ₓMₓZr₁₋ₓCl₆ (M=Ta or Nb; x=0.25, 0.5, 0.75) electrolytes, a positive electrode composite was hand mixed using a mortar and pestle at a weight ratio of 40:58:2 of NCO:NMZC:VGCF. A pellet cell was assembled in 10 mm diameter PEEK die via densification with a hydraulic press using two Ti plunger current collectors. First, 40 mg of NBH powder was pressed to 125 MPa, followed by 35 mg of Na₉Sn₄ pressed to 370 MPa. Finally, approximately 12 mg of NCO composite was added to the opposite side and pressed to 370 MPa. The battery was secured to a cell holder and connected to an electrochemical cycler (e.g., Landhe) programmed to cycle 3 times at C/3, followed by C/10 cycling at room temperature in an Ar-rich glovebox.

### Example 4: X-Ray Diffraction Measurements

Solid electrolyte powders were loaded into 0.5 mm diameter boron-rich capillary tubes (e.g., from Charles Supper Company) while inside an Ar-filled glovebox. The tubes were sealed with clay, transferred out of the glovebox, and flame sealed with a butane torch. XRD patterns were collected over a 5-50° 2θ range with a step size of 0.01° using a Bruker X8-ApexII CCD Sealed tube diffractometer equipped with a molybdenum source radiation (λ_{Mo}=0.7107 Å). All samples were hermetically sealed in 0.5 mm diameter boron-rich capillary tubes. Le Bail fitting was conducted using FullProf Suite.

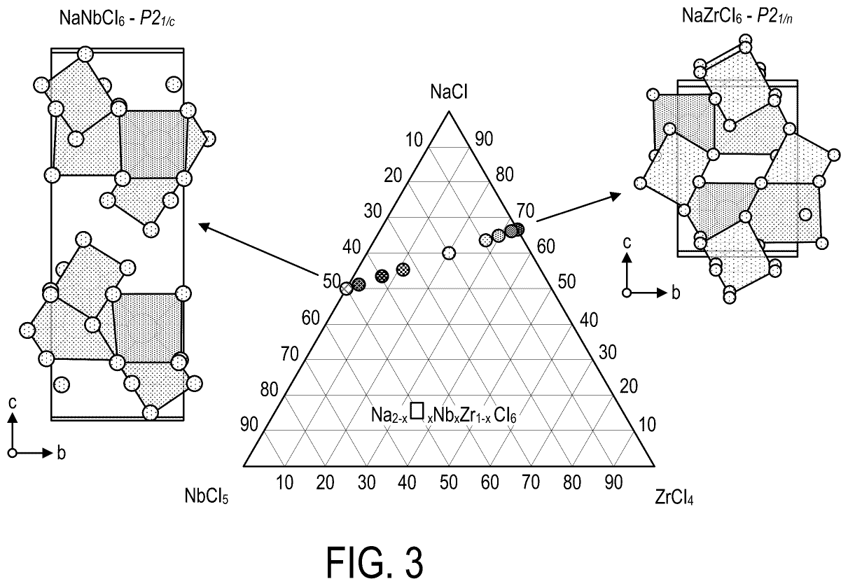

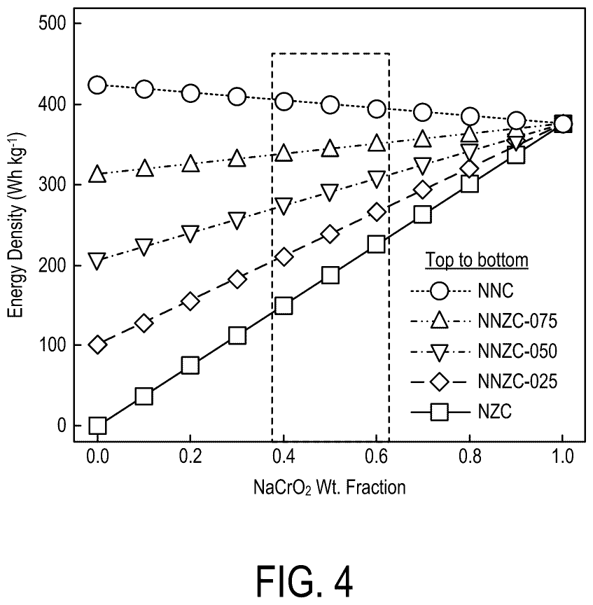

Turning now to FIG. 3, a phase diagram is provided illustrating the synthesis of the aliovalent substituted solid electrolyte material for the examples Metal cations of Nb⁵⁺ and Ta⁵⁺. Both Nb- and Ta-substituted materials were explored in this work to demonstrate the proposed concept for multiple substituent species, but their use for the examples does not limit the valence to 5+. As shown in FIG. 1, the intermediate compositions lie between the end-member structures of Na₂ZrCl₆ (P2_{1/n}) and NaNbCl₆ or NaTaCl₆ (both P2_{1/c}). FIG. 4 depicts the relationship between energy density at the cathode electrode level as a function of the cathode's (NaCrO₂) weight fraction in a cathode composite as described herein. The grey dashed box highlights the weight fractions typically used. Thus, the real energy density within this range is significantly lower than the theoretical energy density of the NaCrO₂ cathode and that by adding an electrolyte which has charge storage capacity can be an effective approach for increasing energy density. Various substitution levels (i.e., NZC, NNZC-025, NNZC-050, NNZC-075, NNC) are shown to further illustrate how the degree of substitution impacts the electrolyte's specific capacity and thus the energy density of the cathode electrode.

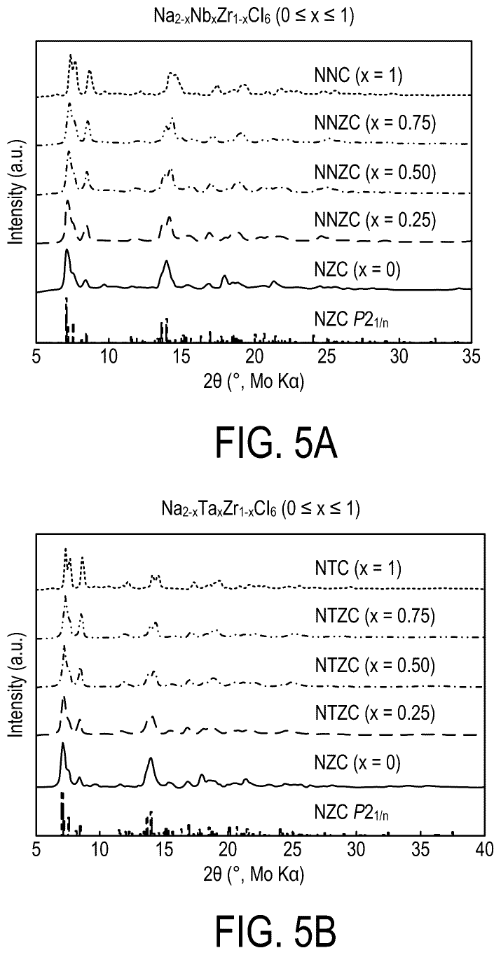

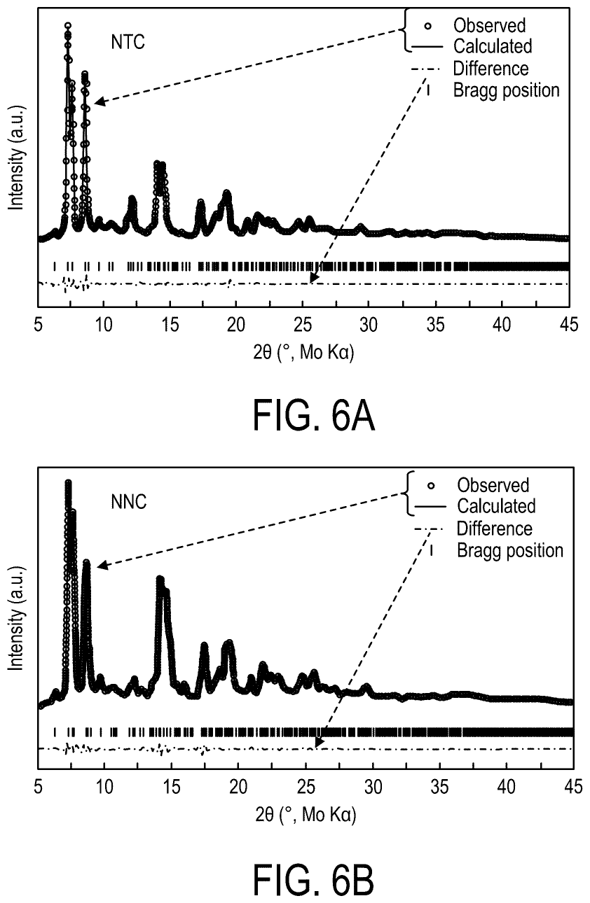

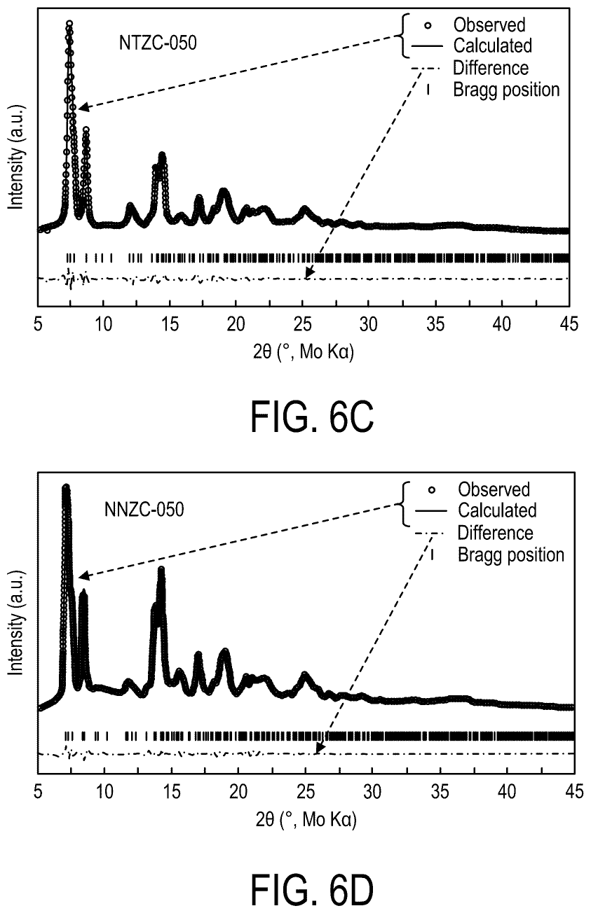

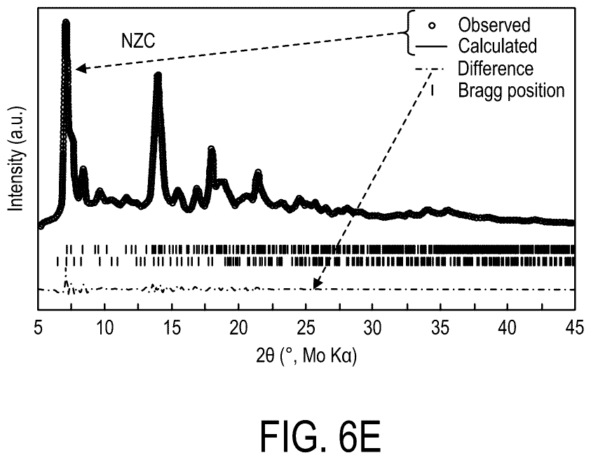

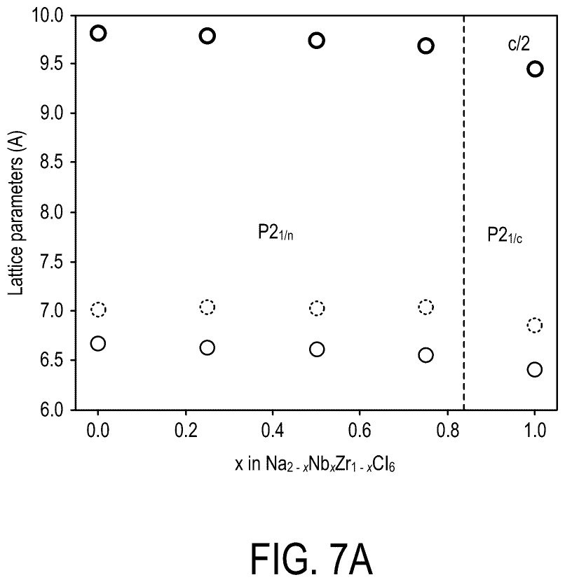

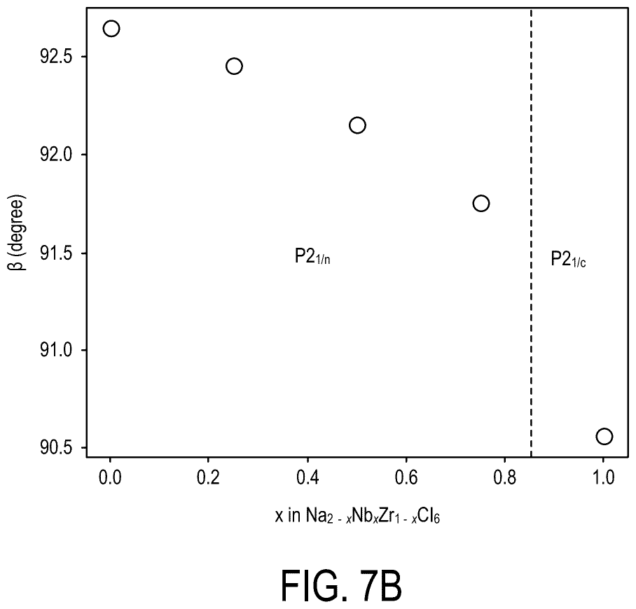

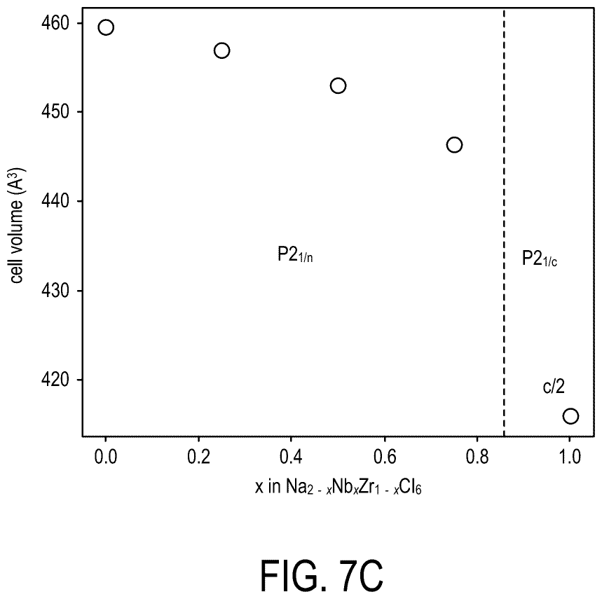

FIG. 5 shows the experimental X-ray diffraction patterns for both Na₂₋ₓNbₓZr₁₋ₓCl₆ (0≤x≤1) and Na₂₋ₓTaₓZr₁₋ₓCl₆ (0≤x≤1) compositions after mechanochemical synthesis (e.g., ball milling). Pure phases are obtained after ball milling in the case of both Nb- and Ta-substitution series. Furthermore, an increasing degree of M⁵⁺ substitution causes Bragg reflections to shift to higher degree two-theta, which can be an indication changing lattice parameters, likely a result of M⁵⁺ incorporation into the NaZrCl₆ structure. A such, Le Bail fitting was conducted on select Na₂₋ₓNbₓZr₁₋ₓCl₆ (0≤x≤1) and Na₂₋ₓTaₓZr₁₋ₓCl₆ (0≤x≤1) compositions and is shown in FIGS. 6A-6E. Le Bail fitting is a method of experimental intensity matching using a space-group model, allowing for the accurate extraction of cell parameters. In both Nb- and Ta-substitution series, there is a clear trend of decreasing lattice parameter and R angle as seen in FIGS. 7A and 7B, respectively, which together lead to a decrease in cell volume as shown in FIG. 7C.

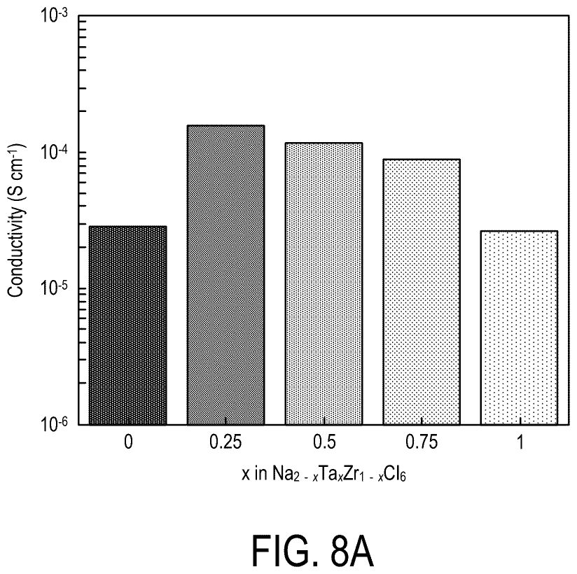

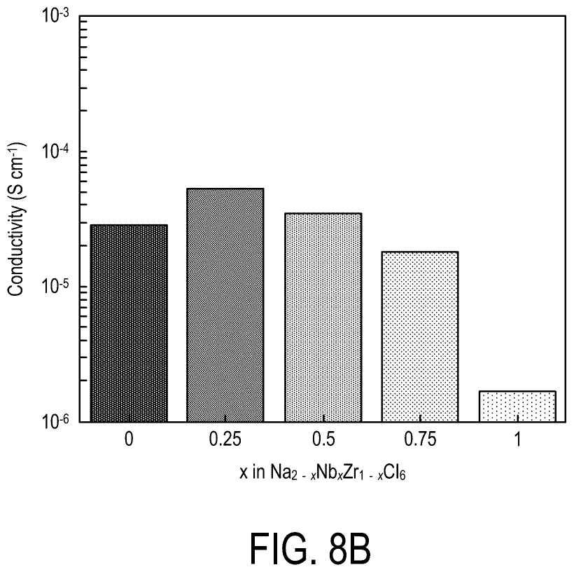

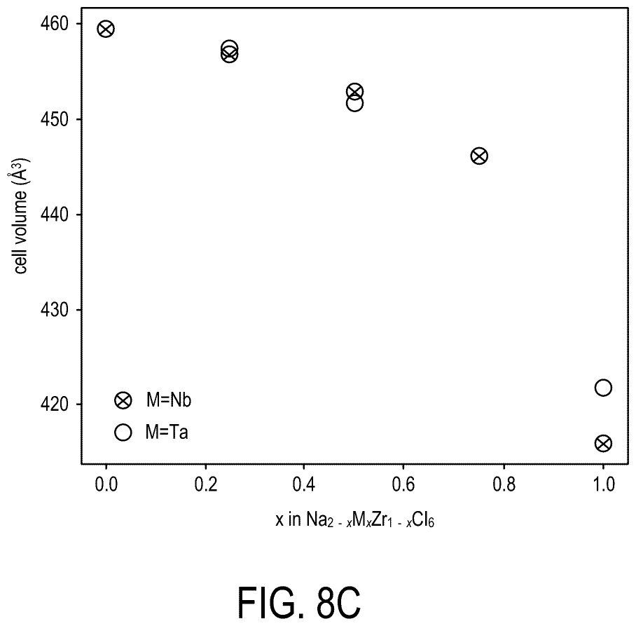

Turning now to FIGS. 8A to 8C, the room temperature ionic conductivities were measured for Na₂₋ₓNbₓZr₁₋ₓCl₆ (0≤x≤1) and Na₂₋ₓTaₓZr₁₋ₓCl₆ (0≤x≤1) compositions. Such measurements revealed an improvement in ionic conductivity with the incorporation of M⁵⁺ substituents, where the conductivity peaked at the x=0.25 composition for both Nb- and Ta-substitution series. There are many factors at play, such as the unit cell size, charge carrier density, and Na-ion vacancy concentration. It is hypothesized that an optimal balancing of such factors may be achieved at the x=0.25 compositions, thus leading to observed maximum conductivity.

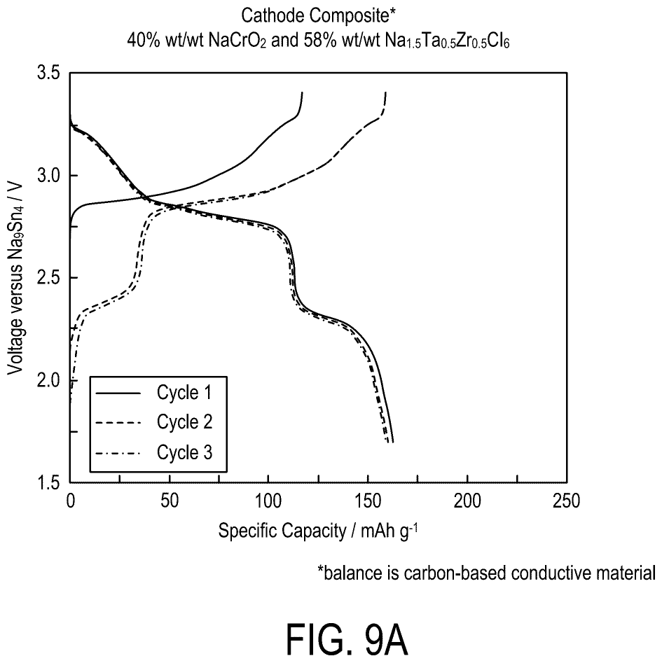

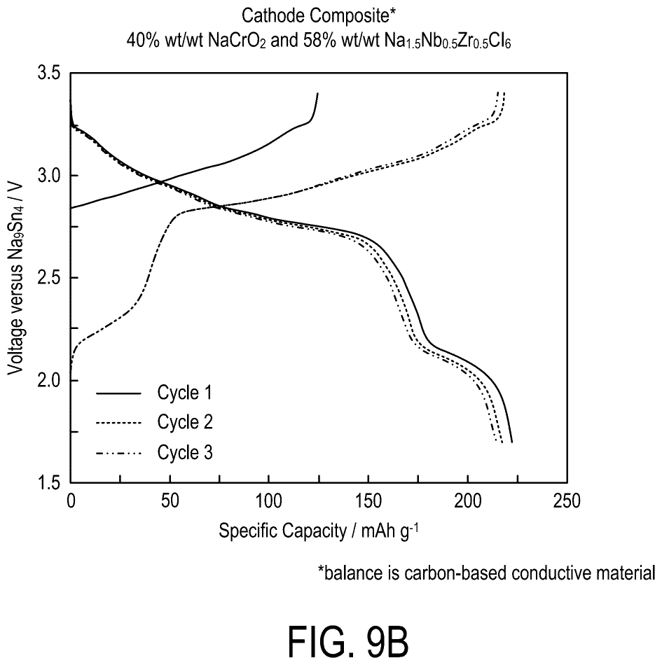

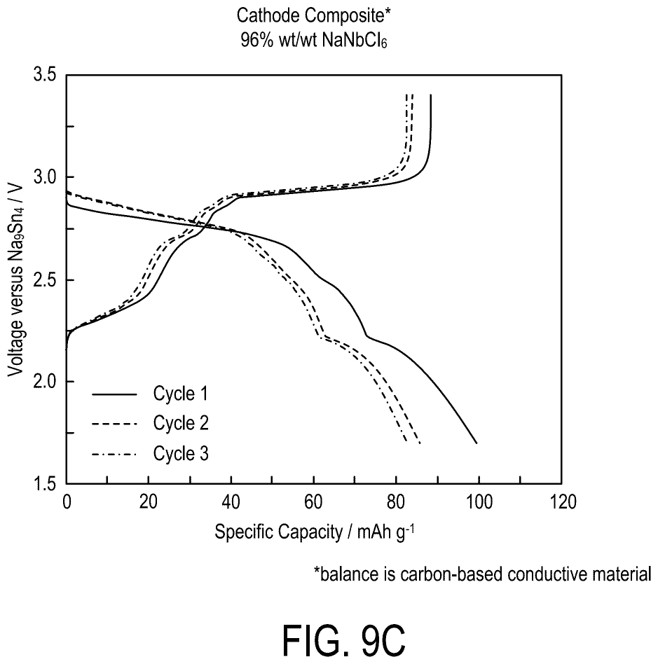

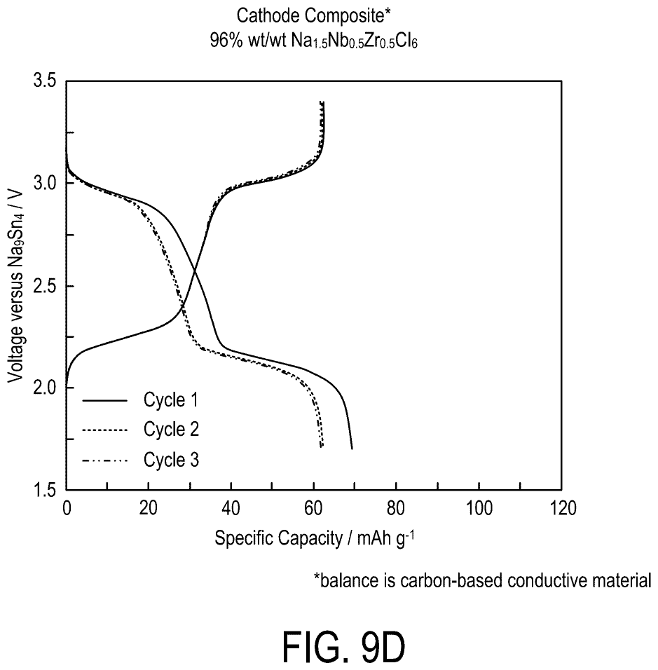

With reference to FIGS. 9A-9D, electrochemical measurements were conducted to probe redox activity and reversibility of the newly synthesized Na₂₋ₓTaₓZr₁₋ₓCl₆ (0≤x≤1) and Na₂₋ₓNbₓZr₁₋ₓCl₆ (0≤x≤1) compositions. Initially, x=0.5 compositions, corresponding to Na_{1.5}Nb_{0.5}Zr_{0.5}Cl₆ and Na_{1.5}Ta_{0.5}Zr_{0.5}Cl₆ were selected as case studies. First cycle voltage profiles show the theoretical capacity of NaCrO₂ (about 120 mAh g⁻¹) is achieved during the first charge, suggesting both materials serve sufficiently as electrolytes, providing the necessary pathways for ion percolation and enable the full utilization of the cathode. nterestingly, on the first discharge, additional slopy regions were observed, corresponding to the redox of both Nb⁵⁺ and Ta⁵⁺ metal centers. Subsequently, increased discharge capacities, about 160 and about 225 mAh g⁻¹, for Na_{1.5}Nb_{0.5}Zr_{0.5}Cl₆ and Na_{1.5}Ta_{0.5}Zr_{0.5}Cl₆, respectively, were observed. Moreover, good reversibility was observed for both materials, with both exhibit high coulombic efficiencies on the third cycle. Next, the NaNbCl₆ and Na_{1.5}Nb_{0.5}Zr_{0.5}Cl₆ compositions were tested as cathode materials, (96 wt. % electrolyte and 4 wt. % carbon additive) rather than as an electrolyte additive (NaCrO₂-free). Voltage profiles for the pure Na_{1.5}Nb_{0.5}Zr_{0.5}Cl₆ material match the combined profile for the cathode electrode consisting of NaCrO₂ and Na_{1.5}Nb_{0.5}Zr_{0.5}Cl₆, suggesting the Nb- and Ta-substituted materials are in fact providing active sites for reversible Na-ion storage in addition to ionic percolation.

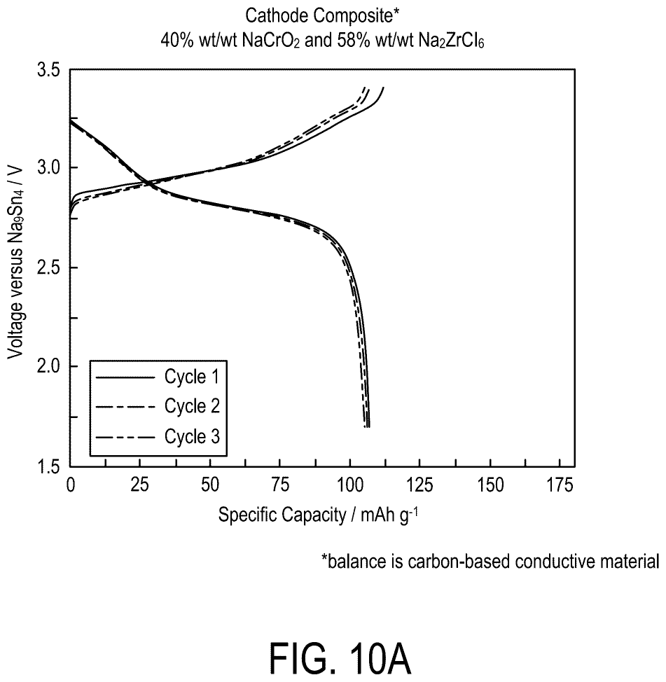

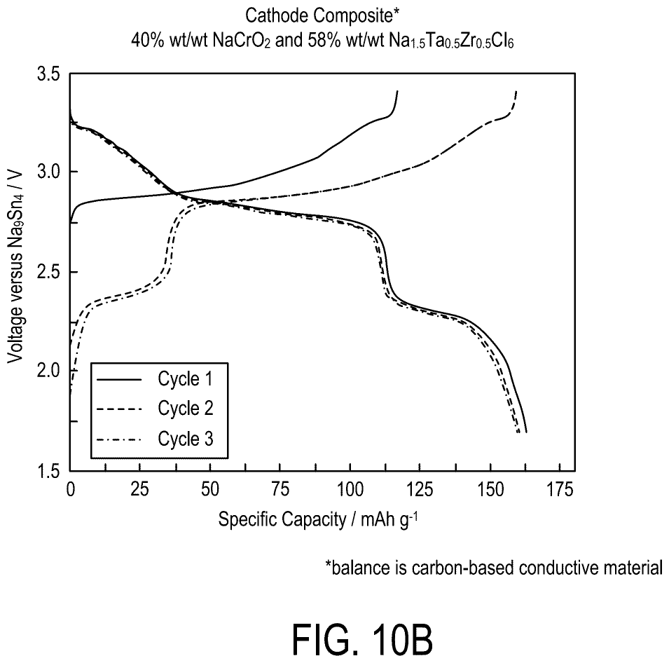

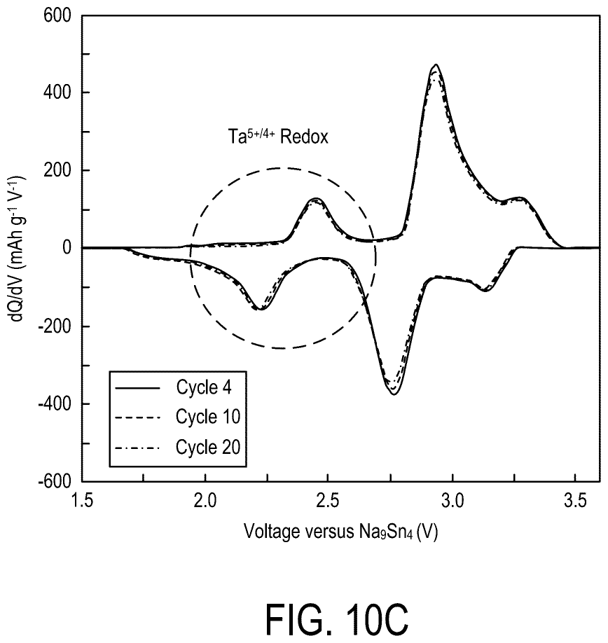

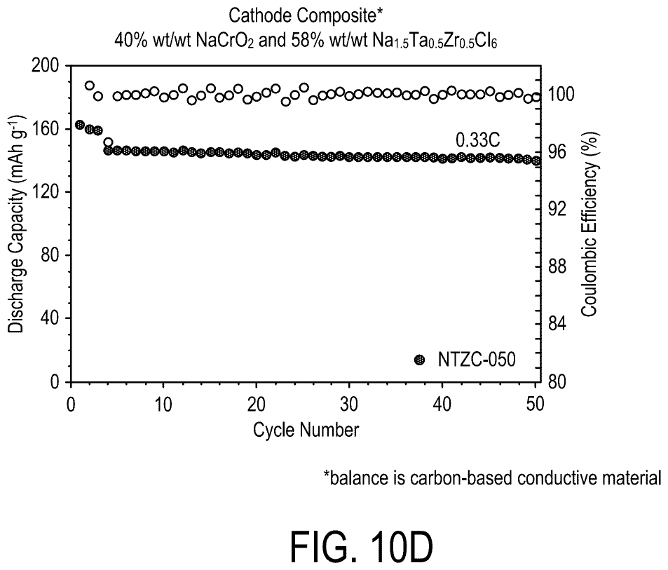

To further probe the reversibility, a cell consisting of a cathode electrode with NaCrO₂ and Na_{1.5}Ta_{0.5}Zr_{0.5}Cl₆ was cycled and are graphically represented in FIGS. 10A and 10B, respectively. dQ/dQ plots, as shown in FIG. 10C, reveal good reversibility of both Ta and Cr redox reactions, highlighting that this novel approach can not only deliver initially enhanced energy density, but does so reversibly over many cycles. With reference to FIG. 10D, long or extended cycling shows good capacity retention can be achieved using such a cell configuration.

An aliovalent substitution approach was disclosed herein and successfully utilized to create solid electrolytes possessing both enhanced ionic conductivities and reversible redox properties, which were then formed into a cathode composite. By leveraging the aliovalent substituted solid electrolytes, the ‘real’ energy density of the cathode electrode can be substantially improved, even at lower cathode weight fractions, including weight fractions below 0.4 as shown in FIG. 4. This method has commercial merit as it directly enhances device performance and is generalizable to other halide-based solid electrolytes, including Li-ion conducting structures as disclosed herein. Moreover, other elements, as indicated above (i.e., V, Cr, Mo, W, Mn, Fe, Co, or Ni of any known valence thereof) can be accommodated by the Na₂ZrCl₆ P2_{1/n} structure, allowing for many other aliovalent substituted solid electrolytes that can be incorporated into or made part of a cathode composite. This not only highlights the potential diversity of materials offered by this concept but also the chemical flexibility of the halide-based crystal structures.

Additional experimental data is available in the inventor's published article, published after the filing date of the priority application hereof, showing that the cathode composites have superior reversibility with capacity retention values of better than 90% and some even exhibited remarkably high specific capacity with capacity retention of 79% after 100 cycles. Ridley et al., Tailoring Chloride solid Electrolytes for Reversible Redox, ChemRxiv, Oct. 24, 2024, DOI:10.26434/chemrxiv-204-v3s5m, which is incorporated herein by reference in its entirety.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A cathode composite comprising:
about 5% wt/wt to about 99% wt/wt of Na_{2+(4-y)x}MₓZr₁₋ₓCl₆ or Li_{2+(4-y)x}MₓZr₁₋ₓCl₆; and
a cathode material as the balance thereof;
wherein x is 0≤x≤1, M is a cation, y is M's valence numbers, and M is selected from the group consisting of a Nb⁵⁺, Ta⁵⁺, V⁵⁺, Cr³⁺, Mo⁶⁺, Mo⁴⁺, W⁶⁺, W⁴⁺, Mn²⁺, Mn⁴⁺, Mn⁵⁺, Fe³⁺, Fe²⁺, Co³⁺, Co²⁺, Ni³⁺, Ni²⁺, and combinations thereof.

2. The cathode composite of claim 1, wherein the Na_{2+(4-y)x}MₓZr₁₋ₓCl₆ or Li_{2+(4-y)x}MₓZr₁₋ₓCl₆ comprise at least 20% wt/wt of the cathode composite.

3. The cathode composite of claim 1, wherein the Na_{2+(4-y)x}MₓZr₁₋ₓCl₆ or Li_{2+(4-y)x}MₓZr₁₋ₓCl₆ comprise at least 50% wt/wt of the cathode composite.

4. The cathode composite, of claim 1, wherein the cathode material is selected from the group consisting of a carbon-based conductive material, a Na-ion O₃-type layered oxide material, a polyanion-type cathode material, and combinations thereof.

5. The cathode composite of claim 1, wherein the cathode material is selected from the group consisting of sodium chromium oxide (NaCrO₂), sodium nickel iron manganese oxide NaNi_{1/3}Fe_{1/3}Mn_{1/3}O₂, iron-based mixed phosphate-pyrophosphate Na₂Fe₃(PO₄)₂(P₂O₇), sodium vanadium phosphate (Na₃V₂(PO₄)₃), sodium titanium, phosphate (NaTi₂(PO₄)₃), sodium iron sulfide (Na₂FeS₂), LiCoO₂, LiMnxNiyCozO₂, LiFePO₄, and LiFexMnyPO₄, and combinations thereof.

6. The cathode composite of claim 4, wherein the carbon-based conductive material is selected from the group consisting of carbon nanofiber, vapor grown carbon fiber, graphene, carbon nanotubes, carbon black, carbon dots, graphite, and combinations thereof.

7. The cathode composite of claim 4, wherein the Na-ion O₃-type layered oxide material or the polyanion-type cathode material is present without the carbon-based conductive material.

8. The cathode composite of claim 4, wherein the carbon-based conductive material is present without the Na-ion O₃-type layered oxide.

9. The solid-state battery of claim 1, wherein the polyanion-type cathode material is present without the carbon-based conductive material.

10. A solid-state battery comprising:
a housing enclosing an anode and a cathode composite, the cathode composite comprising:
about 5% wt/wt to about 99% wt/wt of Na_{2+(4-y)x}MₓZr₁₋ₓCl₆ or Li_{2+(4-y)x}MₓZr₁₋ₓCl₆; and
a cathode material as the balance thereof,
wherein x is 0≤x≤1, M is a cation, y is M's valence numbers, and M is selected from the group consisting of a Nb⁵⁺, Ta⁵⁺, V⁵⁺, Cr³⁺, Mo⁶⁺, Mo⁴⁺, W⁶⁺, W⁴⁺, Mn²⁺, Mn⁴⁺, Mn⁵⁺, Fe³⁺, Fe²⁺, Co³⁺, Co²⁺, Ni³⁺, Ni²⁺, and combinations thereof,
wherein the cathode composition functions as a cathode and as a solid electrolyte.

11. The solid-state battery of claim 10, wherein the Na_{2+(4-y)x}MₓZr₁₋ₓCl₆ or Li_{2+(4-y)x}MₓZr₁₋ₓCl₆ comprise at least 20% wt/wt of the cathode composite.

12. The solid-state battery of claim 10, wherein the Na_{2+(4-y)x}MₓZr₁₋ₓCl₆ or Li_{2+(4-y)x}MₓZr₁₋ₓCl₆ comprise at least 50% wt/wt of the cathode composite.

13. The solid-state battery of claim 10, wherein the cathode material is selected from the group consisting of a carbon-based conductive material, a Na-ion O₃-type layered oxide material, a polyanion-type cathode material, and combinations thereof.

14. The solid-state battery of claim 10, wherein the cathode material is selected from the group consisting of sodium chromium oxide (NaCrO₂), sodium nickel iron manganese oxide NaNi_{1/3}Fe_{1/3}Mn_{1/3}O₂, iron-based mixed phosphate-pyrophosphate Na₂Fe₃(PO₄)₂(P₂O₇), sodium vanadium phosphate (Na₃V₂(PO₄)₃), sodium titanium, phosphate (NaTi₂(PO₄)₃), sodium iron sulfide (Na₂FeS₂), LiCoO₂, LiMnxNiyCozO₂, LiFePO₄, and LiFexMnyPO₄, and combinations thereof.

15. The solid-state battery of claim 10, wherein the carbon-based conductive material is selected from the group consisting of carbon nanofiber, vapor grown carbon fiber, graphene, carbon nanotubes, carbon black, carbon dots, graphite, and combinations thereof.

16. The solid-state battery of claim 10, wherein the Na-ion O₃-type layered oxide is present without the carbon-based conductive material.

17. The solid-state battery of claim 10, wherein the carbon-based conductive material is present without the Na-ion O₃-type layered oxide.

18. The solid-state battery of claim 10, wherein the polyanion-type cathode material is present without the carbon-based conductive material.

19. The solid-state battery of claim 10, wherein the cathode material is the sole solid electrolyte.

20. A method of making a cathode composite, the method comprising:
providing an aliovalent substituted solid electrolyte material having a general formula of 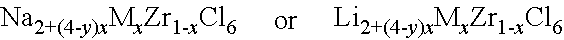
wherein x is 0≤x≤1, M is a cation, and y is M's valence numbers; and M is selected from the group consisting of a Nb⁵⁺, Ta⁵⁺, V⁵⁺, Cr³⁺, Mo⁶⁺, Mo⁴⁺, W⁶⁺, W⁴⁺, Mn²⁺, Mn⁴⁺, Mn⁵⁺, Fe³⁺, Fe²⁺, Co³⁺, Co²⁺, Ni³⁺, Ni²⁺, and combinations thereof;
providing a cathode material;
mixing the aliovalent substituted solid electrolyte material with the cathode material to form a cathode composite.
